(19) United States
(12) Patent Application Publication
(10) Pub. No.: US 2012/0216712 A1
(43) Pub. Date: Aug. 30, 2012

(54) COMPOSITION AND METHOD FOR LOW TEMPERATURE DEPOSITION OF RUTHENIUM

(76) Inventors: Ajit Paranjpe, Basking Ridge, NJ (US); Vinayak V. Vats, Pleasanton, CA (US); Randhir Bubber, Fremont, CA (US)

(21) Appl. No.: 12/866,960

(22) PCT Filed: Jan. 19, 2010
(86) PCT No.: PCT/US2010/021375

§ 371 Date: May 14, 2012

Related U.S. Application Data
(60) Provisional application No. 61/145,324, filed on Jan. 16, 2009.

(51) Int. Cl. C09D 5/00

(52) U.S. Cl. 106/287.18

(57) ABSTRACT

Composition and method for depositing ruthenium. A composition containing ruthenium tetroxide RuO₄ is used as a precursor solution 608 to coat substrates 400 via ALD, plasma enhanced deposition, and/or CVD. Periodic plasma densification may be used.

### CROSS-REFERENCE TO RELATED APPLICATIONS

The present application is the US National Phase and claims the benefit of Priority to PCT application US2010/021375 filed Jan. 19, 2010, that claims the benefit of U.S. Provisional Application Ser. No. 61/145,324, filed Jan. 16, 2009, the disclosures of which are hereby incorporated by reference herein in their entirety.

### BACKGROUND

The present invention relates to low temperature deposition of conformal ruthenium as a plating seed for various steps involved in the manufacture of devices such as thin film magnetic heads for data storage drives.

Recently, perpendicular magnetic recording (PMR) has been introduced in order to maintain the 40% growth rate in areal recording density of hard disk drives (HDD) demanded by the ever increasing data storage needs for consumer, business, and enterprise applications. The introduction of PMR has mandated several changes to the architecture of thin film magnetic heads such as trapezoidal shaped writer poles and leading/trailing/side shields that envelop the writer pole. The trapezoidal shaped writer pole has greater immunity to skew of the writer pole relative to the magnetic track on the media, while the shields enveloping the writer pole minimize inter-track and intra-track interference while writing adjacent data bits.

One method to fabricate a trapezoidal shaped writer pole is to etch a trapezoidal shaped trench into a thick alumina layer and then fill the trapezoidal pole with a magnetic material with a high saturation magnetization through a plating process. In order to achieve a void-free fill of the trench with the magnetic material while retaining the desired magnetic properties (such as high saturation magnetization, low easy/hard axis coercivity, low anisotropy, high frequency response, and low remnant magnetization), a plating seed that lines the inside of the trench and covers the top surface of the alumina is necessary. Ruthenium is known to be well-suited for plating of high moment magnetic materials such as CoFe, CoNiFe, FeCo, etc. Apart from serving as a good plating seed, high moment materials plated on Ru have good magnetic properties that are essential for the effective functioning of the magnetic head.

One method to encapsulate the writer pole with a soft magnetic shield is to plate the soft magnetic shield over the top and sides of the writer pole with an intervening non-magnetic spacer layer that also serves as a plating seed. Once again, Ru is to be well-suited for plating of soft high moment magnetic materials such as NiFe, NiFeCo, etc.

For both these applications, a conformal layer of ruthenium that evenly coats the inside of the trench or the exposed surfaces of the 3-D writer pole structure with excellent thickness control and uniformity over the entire substrate surface is required. Of the known deposition techniques, atomic layer deposition (ALD) and conformal chemical vapor deposition (conformal CVD) are the only commercially viable methods to provide conformal Ru deposition. Both these methods require elevated temperatures and substrate heating. However, in order to prevent damage to the thin film head structures during deposition, a constraint of deposition temperatures below approximately 200° C. and perhaps even as low as 170° C. must be met.

Improved compositions and methods are needed for low temperature deposition of conformal ruthenium.

### SUMMARY OF THE INVENTION

In one embodiment, a chemical composition includes first and second solvents, and ruthenium tetroxide (RuO₄) in the first and second solvents at a concentration ranging from 1.0 wt. % to 1.7 wt. %.

In another embodiment, a process includes placing a first solvent and a second solvent in a first mixture with a first ratio of the first solvent to the second solvent in a vessel. The first solvent and the second solvent in the vessel are vaporized to form a vapor and releasing the vapor from the vessel. In response to releasing the vapor from the vessel, a determination is made of a second ratio of the first solvent to the second solvent in a second mixture remaining in a vessel. In response to determining the second ratio, a third ratio of the first solvent to the second solvent is determined for a volume of a third mixture to add to the second mixture remaining in the vessel and reestablish approximately the first ratio in the vessel.

In yet another embodiment, a process includes obtaining a mixture containing RuO₄, a first solvent, and a second solvent combined with the first solvent in a ratio of 30 vol. % to 70 vol. %, and placing the mixture in a vessel coupled in fluid communication with a deposition system. A deposition process is conducted that supplies a vapor containing the first solvent, the second solvent, and RuO₄ from the vessel to the deposition system, and that depletes the first solvent from the mixture in the vessel at a higher rate than the second solvent. The vessel is replenished using a replenishment mixture containing RuO₄, the first solvent, and the second solvent combined with the first solvent at a second ratio that is greater than 30 vol. % to 70 vol. %.

### BRIEF DESCRIPTION OF THE DRAWINGS

FIG. 1 is a flow chart of process steps per one embodiment of the process.

FIG. 2 is a flowchart showing additional steps per the embodiment of FIG. 1.

FIG. 3 is a flowchart showing additional steps per the embodiment of FIG. 1.

FIG. 4 is a schematic diagram illustrating the structure of the deposited materials per the processes of FIGS. 1-3.

FIG. 4A is an ABS (Air Bearing Surface) view of a trapezoidal shaped writer pole formed using the processes of the flow charts of FIGS. 1-3.

FIG. 5 is a general schematic illustration of a process module for conformal deposition of ruthenium.

FIG. 6 is a schematic illustrating further aspects of the process module of FIG. 5.

FIG. 7 is a perspective view showing the chamber body and the multizone showerhead of the process module of FIG. 5.

FIG. 8 is a cross-sectional schematic view of a chuck that would be within the process chamber of FIG. 7.

FIG. 9 is a schematic view of a refill and bubbler system used in the process module of FIG. 5.

FIG. 10 is a chart displaying percent volume change of ampoule solvents and ampoule pressure as described in the specification.

FIG. 11 is a chart displaying percent volume change of ampoule solvents as described in the specification.

### DETAILED DESCRIPTION OF THE INVENTION

The quality of ruthenium films deposited is strongly influenced by the composition and purity of the RuO₄ (ruthenium tetroxide) and the at least one solvent in which the RuO₄ is dissolved. ToRuS™, which is commercially available from Air Liquide, is a chemical compound composed of RuO₄ dissolved in a mixture of two or more solvents, such as non-flammable fluorinated solvents. The compositions of the various embodiments of the invention contrast with a conventional ToRuS™ blend that contains RuO₄ at only 0.4 wt % or lower. The following compositions are believed to yield specular, silvery, low resistivity films, having an oxygen content of less than 1 at. %, with 90% to 105% step coverage at 200° C.

The composition includes at least one wt. % of RuO₄. In one embodiment, the composition includes 1.0 wt. % to 1.7 wt. % RuO₄. In another embodiment, the composition includes 1.0 wt. % to 1.2 wt % RuO₄. In yet another embodiment, the composition includes 1.6 wt. % to 1.7 wt. %. The maximum content of RuO₄ in the composition may be greater than 1.7 wt. % as constrained by solubility limits for RuO₄ in the at least one solvent. The upper limit of the range and solubility may also depend upon environmental conditions, such as temperature, experienced by a vessel containing the composition.

The composition includes at least two solvents and, in one embodiment, a first solvent #1 (S1) at a concentration of less than, or equal to, 30% by volume and a second solvent #2 (S2) at a concentration of greater than, or equal to, 70% by volume in a mixture of the two at room temperature. Exemplary solvents suitable for use in the composition are disclosed, for example, in U.S. Pat. No. 7,544,389 to Dussarat et al., which is hereby incorporated by reference herein in its entirety.

The water content of the composition is less than 10 ppm in one embodiment and, in another embodiment, is less than 5 ppm. As the concentration of RuO₄ is increased in the composition, a greater amount of water can be tolerated.

The purity and consistency of the composition may be maintained by, for example, storing the composition in a container with a surface coating or liner that is inert to the composition, thereby preventing degradation of the composition during storage. Although a glass liner may be used, a conformal bilayer coating of Si/SiO₂ on the inner surface of the container is preferred.

The composition may be stored at room or ambient temperature to prevent a possible slow, long-term decomposition of the chemical.

The precursor may be delivered to the chamber by bubbling a carrier gas, such as Ar, through an ampoule containing the composition. The carrier gas flow rate and the pressure in the head space of the ampoule are regulated in order to deliver the desired quantity and concentration of precursor to the reactor. While being consumed, the composition may change gradually so that the relative proportions of the solvents from 30:70 for solvent #1: solvent #2 to approximately 20:80 which typically signals end of ampoule life. The relative proportions may be allocated in volume percentages. If a remote refill is used to replenish the ampoule, the composition in the refill canister must be such that post-refill the composition is returned to the starting value of 30:70. This will be described further with respect to the Figures.

The quality of ruthenium films is strongly influenced by process conditions. RuO₄, the active chemical in the composition, is extremely reactive. If the following conditions are not observed, dark/black regions of films with higher impurity content of oxygen (from the RuO₄) and fluorine (from the solvents) may be obtained, rather than pure, smooth, silvery looking, highly specular films with good thickness and sheet resistance uniformity across the wafer.

With regard to process conditions, the composition may be introduced through a temperature controlled showerhead plate that is parallel to and in close proximity to the wafer surface which is maintained at 150° C. to 220° C. This spacing is typically less than 18 mm between the showerhead and the substrate surface. The close proximity of the showerhead ensures that the RuO₄ is transported to the wafer surface without decomposing during transit.

The composition and the co-reactant H₂ may be injected alternately to minimize gas phase reactions that partially decompose the RuO₄ into RuO₂. These pulses are 0.5 seconds to 10 seconds in duration for the composition and 0.5 seconds to 10 seconds in duration for H₂. The composition pulses and H₂ pulses may be separated by 0.5 seconds to 10 seconds pulses of an inert gas such as Ar. Each set of four pulses constitutes a deposition cycle which deposits 3 to 4 angstroms of Ru on the wafer surface.

The specific flow rates for the carrier gas, H₂, and the purge gas are specific to the wafer size and CVD chamber configuration. For substrates that are 150 mm-200 mm in diameter, typical flow rates are: 50 sccm to 200 sccm Ar carrier gas flowing through an ampoule with a head space pressure maintained in the range of 40 Torr to 500 Torr, 200 sccm to 400 sccm purge gas, and 100 sccm to 500 sccm H₂. Chamber pressure is maintained at 0.2 Torr to 0.8 Torr during all the pulses.

The purge gas is switched from the top of the chamber during the purge sequence to the bottom of the chamber during the pulse sequence of the reactants H₂/RuO₄ precursor to maintain a stable and nearly constant pressure during the whole process.

During the plasma enhanced ALD (PE-ALD) process steps of the recipe, a small showerhead to substrate spacing is used during the RuO₄ delivery pulse to ensure adequate delivery to the wafer surface while the spacing is increased during the plasma activation step of the recipe to ensure a stable and uniform plasma.

For various recipe steps, the process pressure in the chamber is either controlled by a throttling gate valve leading to a turbo-pump or by a throttling gate valve leading to a dry pump. The turbo pump is typically used for recipe steps that require pressures below 150 mTorr while the dry pump is used for recipe steps that require pressures above 300 mTorr.

To ensure that an abundant supply of hydrogen is delivered to the chamber during the H₂ dosing step, the H₂ mass flow controller continually charges a reservoir at a steady rate, while the reservoir is periodically emptied into the chamber during the H₂ dosing step. The reservoir could be an extension of the gas line between the mass flow controller (MFC) and the delivery valve proximate to the showerhead or a small fixed volume attached to the gas line. The volume of the reservoir is selected to ensure that the pressure does not exceed the supply pressure to ensure that the mass flow controller continues to maintain flow at its setpoint value. Also the pressure should be high enough so that the majority of the reservoir contents are delivered to the chamber during the short H₂ pulse. These two constraints set the optimal volume and are typically the equivalent of 40-60″ long, 0.25″ ID gas delivery line.

Ru films deposited under the previously described conditions tend to have high tensile stress (typically >1 GPa) and also may lack sufficient adhesion strength to the underlying dielectric films, such as SiO₂ and alumina. In order to overcome these potential limitations, one or more of the following process improvements can be implemented.

Before deposition, the surface may be cleaned with an in-situ sputter etch or an ex-situ sputter etch (but without breaking vacuum).

The deposition may be plasma enhanced deposition by igniting a plasma when the H₂ is introduced into the process chamber. This hastens the surface reaction with the chemisorbed RuO₄, and the ion bombardment of the growing film surface reduces the stress in the film. Plasma enhanced deposition also results in more uniform nucleation of the Ru film on the wafer surface. Typically, the initial 10 cycles to 20 cycles of deposition are performed in this mode. This is referred to as a PE-ALD (plasma enhanced ALD) recipe. PE-ALD can also reduce the surface roughness of the deposited film.

The growing film may be periodically exposed to a plasma that irradiates the surface with ions of controllable energy in order to reduce the stress in the film to an acceptable level. Such plasma densification cycles may be performed every 5 cycles to 20 cycles of deposition. The densification may be performed for 10 seconds to 30 seconds in an Ar plasma at 0.05 Torr to 0.5 Torr with an RF wafer bias of 100 Volts to 500 Volts and 200 watts to 500 watts.

A glue layer, such as another metal or metal nitride, may be included that promotes good adhesion to the underlying dielectric as well as the over-lying Ru. Of the various metal nitrides, tungsten nitride (WNₓ) may be well-suited for this application because WNₓ can be conformally deposited using either atomic layer deposition or plasma enhanced atomic layer deposition processes that operate at the same temperature as the conformal Ru deposition. Another option is a bilayer of an adhesion layer, such as Ti, Cr, Ta or the like, that provide good adhesion to the underlying oxide with an upper layer of Ru that provides good adhesion and a good nucleation surface for the conformal Ru deposition.

A laminate of Ru and one or more lower resistivity films may be deposited to lower the effective resistivity of the metallic stack for a given total stack thickness. This may be important when a low sheet resistance is desirable for uniform plating over a thin plating seed layer. The lower resistivity materials would also be deposited via ALD or CVD. Such lower resistivity materials that can be deposited by sub 200° C. deposition processes include, but are not limited to, Cu, Co, Ni, Al, Pd, Pt, and Ir.

Exemplary process steps for depositing ruthenium are disclosed, for example, Microelectronic Engineering 83 (2006) 2248-2252, which is hereby incorporated by reference in its entirety, and U.S. Pat. No. 7,544,389 to Dussarat et al., incorporated by reference above.

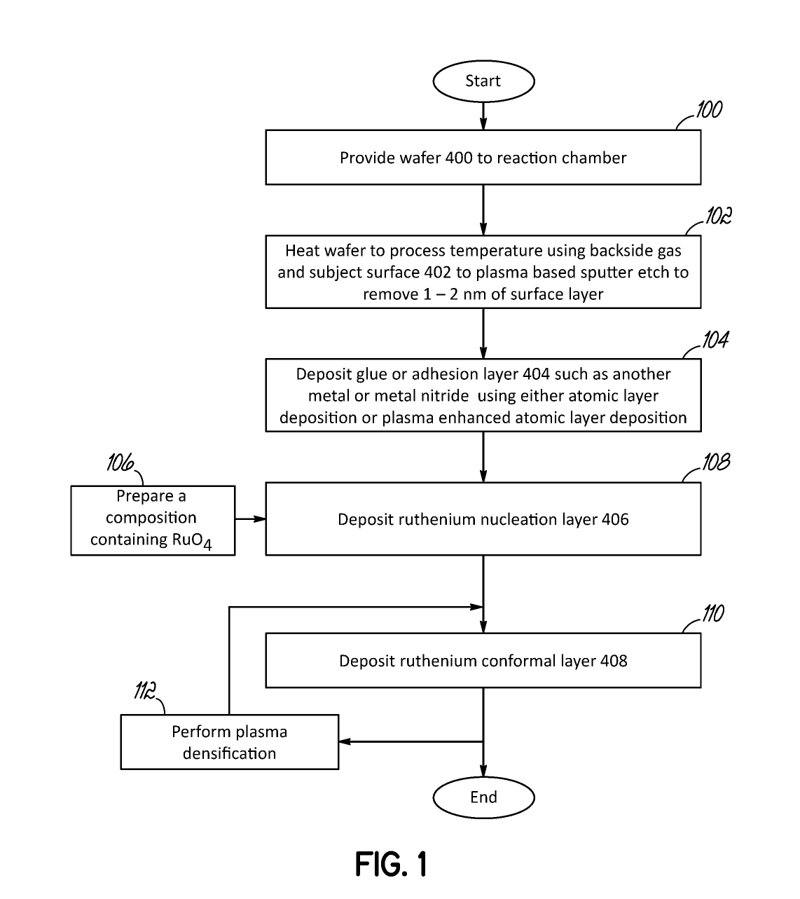

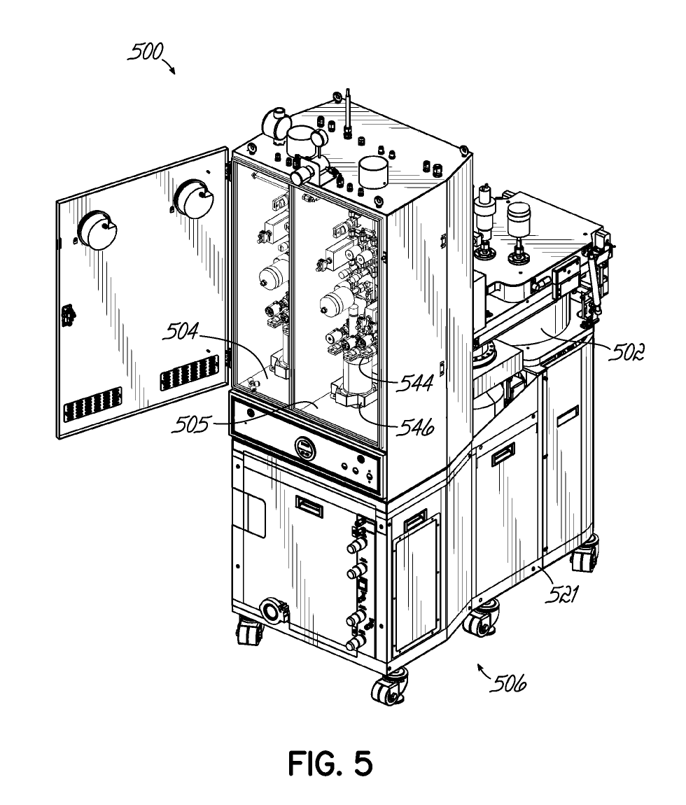

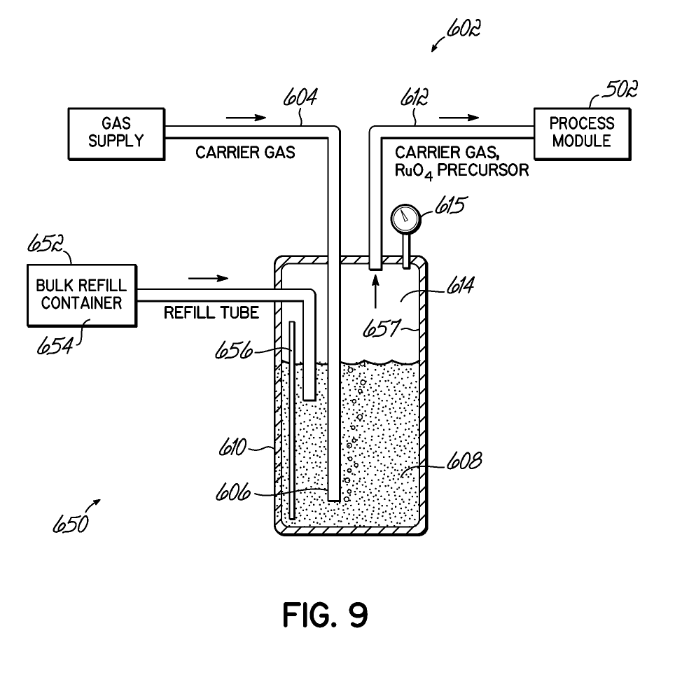

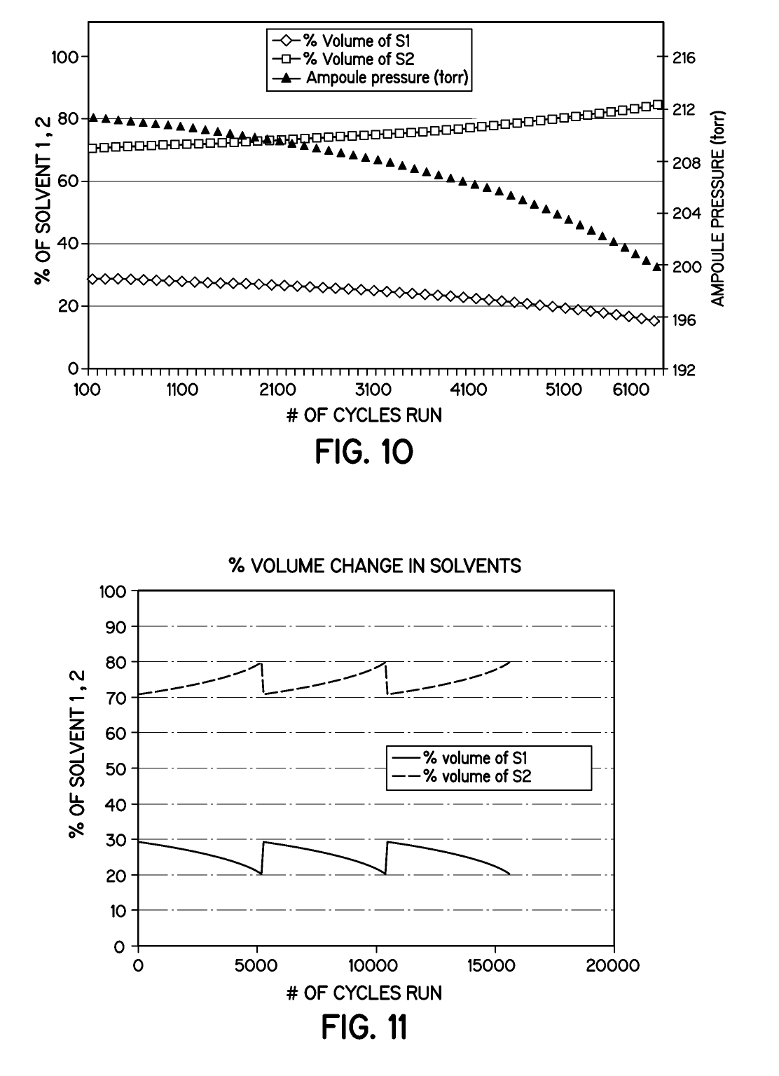

The description above will now be further detailed with reference to the specified figures. The basic sequence of operations to deposit a conformal ruthenium film on the substrate is explained with reference to the attached FIGS. 1-4. FIGS. 5-9 illustrate part of a device used for manufacture, comprising a process module 500 having a chamber 502, one or two gas delivery and precursor delivery systems 504, 505 having a replenishment system 650 and a vacuum pumping system 506. FIGS. 10 and 11 further describe the replenishment system 650 of FIG. 9.

The typical sequence of steps is as follows: As depicted in FIGS. 1-4, substrate wafers 400 which are typically a 150 mm or 200 mm diameter silicon or AlTiC wafer 400 with a surface 402 are placed in a load-lock (not shown) of the processing tool and the load-lock (not shown) is pumped down to vacuum levels (typically 10⁻⁵ Torr to 10⁻⁴ Torr). In step 100, all gas flows in the chamber 502 are stopped and the chamber is pumped down to base pressure (which is typically 10⁻⁶ Torr to 10⁻⁴ Torr) by a turbo-pump 510. A slit valve (not shown) that connects the process module 500 to a central wafer handler (not shown) opens thereby providing a wafer robot (not shown) in the central wafer handler access to the process module 500. The robot in the central wafer handler transfers a wafer 400 from the pumped down load-lock into the chamber 502. The wafer 400 is loaded onto wafer lift pins (not shown). The robot end-effector (not shown) retracts from the process chamber and the slit valve is closed. A movable, heated (typically ˜200° C.), temperature controlled chuck 516 (FIG. 8) moves upwards to engage with the wafer 400 and then wafer clamp ring 514. The wafer clamp ring holds the wafer 400 securely against the chuck 516. If an electrostatic chuck is used, the wafer is placed on wafer lift pins, the chuck moves upward to lift the wafer off the pins and then electrostatically chucks the wafer. The chuck then continues to move upwards to engage with the wafer ring. In this case the wafer ring may not physically contact the wafer since it does not provide a clamping function. Physical contact may be implemented to achieve a physical exclusion of the film from the wafer edge. Edge exclusion of the deposition can also be achieved by providing a purge gas around the periphery of the wafer that escapes into the process chamber through a small gap between the wafer surface and an overhang on the wafer ring.

In step 102 (FIG. 1), the backside gas in the heated chuck 516 is turned on to heat the wafer 400 rapidly and uniformly to process temperature (˜200 ° C.). Helium is a commonly used heat transfer gas due to its high thermal conductivity. The backside gas pressure between the wafer 400 and the chuck 516 is in the range of 5-30 Torr for maximum heat transfer rates. Both Si and AlTiC wafers heat up to within 5° C. of the set-point in 20-60 seconds. The surface 402 of wafer 400 is subjected to a plasma based sputter etch from a shower head 518 to remove 1-2 nm of material from the surface 402. Typical conditions are: Ar or Ar/H₂ at 20-100 sccm flow, 200-500 W (Watt) RF power @ 13.56 MHz, pressure of 5-20 mTorr, etch time of 20-200 seconds, and substrate to showerhead spacing of 50-100 mm. The specific process conditions are chosen to maximize uniformity and etch rate repeatability for the targeted material removal and are dependent on the specific details of the chamber 502 design. The process gases are introduced through a combination of the multi-zone showerhead 516, as well as through chamber purge ports (not shown). In other embodiments, a single zone showerhead may be used. At the termination of the process, the gas flows are shut off and the chamber 502 may be pumped down to base pressure. Since the module 500 is designed to be docked to a central wafer handler that may accommodate additional modules, the pre-clean sputter etch may be performed in a separate etch module (not shown) such as a sputter etch module or an ion beam etch module.

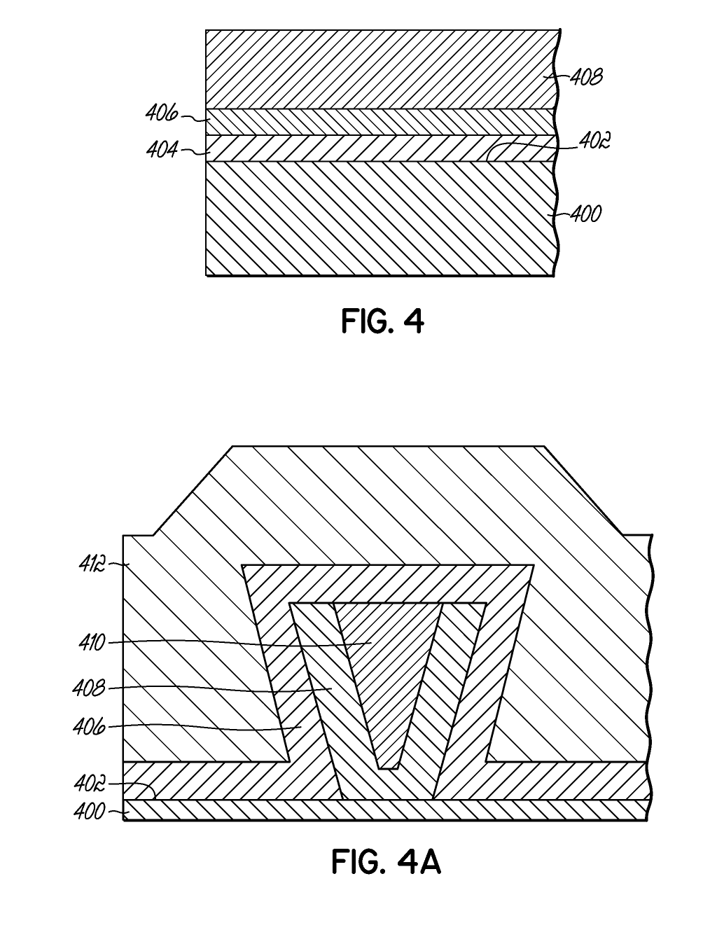

In step 104, (FIG. 1) a glue or adhesion layer 404, (FIG. 4) such as another metal or metal nitride which promotes good adhesion to the underlying dielectric on wafer 400 as well as the over-lying Ru, is deposited. The need for this layer depends on the application and the processing sequence that the wafer will be subjected to following conformal Ru deposition. Alternatively the glue or adhesion layer 404 may be deposited in a separate module (not shown) via sputtering (PVD), ion beam deposition (IBD), CVD or ALD prior to placing the wafer 400 in process module 500.

In step 106, the composition containing RuO₄ is prepared, stored, and provided to the chamber in one of the following representative compositions and manner, described here in a list for descriptive clarity:
1. A composition containing at least 1.0 wt % of RuO₄, and in various alternative embodiments 1.0 wt. % to 1.7 wt. % RuO₄, 1.0 wt. % to 1.2 wt. % RuO₄, or 1.6 wt. % to 1.7 wt %.
2. At least two solvents and, in one representative embodiment, a first solvent #1 at a concentration of 30% or less, and a second solvent #2 at a concentration of 70% or greater.
3. A range of solvent concentrations that will enable the above process to yield smooth and specular ruthenium.
4. A separate composition in a bulk refill container that will be further described with reference to FIGS. 9-11.
5. <10 ppm water content. and
6. the composition is stored in a container at room temperature with a surface coating or liner that is inert to the composition thereby preventing degradation during storage.

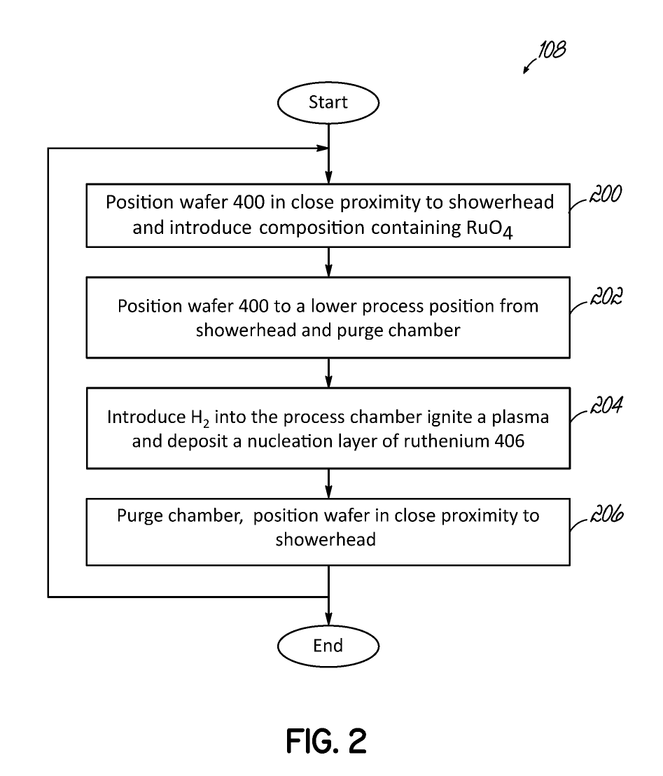

In step 108, a layer 406 of 5-40 angstroms of ruthenium may now be deposited via plasma enhanced ALD (PE-ALD). Step 108 comprises multiple sub-steps 200-206 that are will now be described with reference to FIG. 2.

In step 200, the chuck 516 is moved so that the wafer 400 is in close proximity (5-20 mm) of the showerhead. A composition containing RuO4 in an inert carrier gas is introduced for 0.5-10 seconds through one zone of the showerhead 516. The flow rate of the carrier gas is 50-200 sccm while that of the composition is 50-200 sccm. An inert purge gas at 100-400 sccm is introduced through the purge port. The chamber pressure is maintained in range of 0.2-0.8 Torr either by a throttling valve mounted on the port connected to the dry pump or by adjusting the purge flow.

In step 202, after the surface of the substrate has been dosed, the flow of the vapor and carrier gas mixture is shut-off and a purge gas is introduced for 0.5-10 seconds through the showerhead 518 and the purge gas inlet port at a flow rate of 100 sccm to 400 sccm to sweep the composition from the chamber volume and also remove excess composition that may be physisorbed on the substrate leaving a chemisorbed layer on the wafer surface. Simultaneously, the chuck 516 may be moved downwards to a lower process position (substrate to showerhead spacing of 50 mm to 100 mm) while still keeping the wafer clamped and the pressure controlled to the range of 50-300 mTorr by either a throttling valve 520 mounted on the port connected to the turbo pump 510, or by adjusting the purge flow. When the turbo pump is being used as the primary pump, a gate valve on the port connected to a dry pump is closed and vice-versa.

Once the chamber has been purged of excess vapor and carrier gas, in step 204 H₂ is introduced for 0.5-10 seconds through the second zone on the showerhead.

When the H₂ delivery valve connected to the showerhead is opened, the H₂ stored in the reservoir is efficiently delivered to the process chamber. As the H₂ is delivered to the chamber, an RF plasma at 200-500 W power and substrate to showerhead spacing of 50-100 mm is ignited by applying 13.56 MHz RF to the chuck in order to dissociate the gas into atomic H and ions such as Ar⁺, H⁺, and H₂⁺. The atomic H in conjunction with ion bombardment of the substrate surface by Ar⁺, H⁺, and H₂⁺ results in the reduction of the chemisorbed RuO₄ to form 2-4 A of Ru. During this step, the pressure is controlled to the range of 50-300 mTorr either by a throttling valve mounted on the port connected to the turbo pump or by adjusting the purge flow.

A single zone showerhead can also be used, for this, and all other process steps although this will not be repeatedly stated in this disclosure, provided the purge gas flows and pulse durations are long enough to ensure that the majority of the vapor and carrier gas with RuO₄ is removed from the showerhead before the next reactant (H₂) is introduced. In some embodiments, it may be easier to achieve good gas injection uniformity and thus good deposition uniformity with a single zone showerhead. A single zone showerhead may also be easier to construct. The embodiments of the present are not limited use with a multi-zone showerhead. An inert purge gas at 100-400 sccm is introduced through the purge port and may additionally be introduced through the showerhead. In the case of pulsed CVD which is the mode in which this process operates, it is sufficient to ensure that the majority of the vapor and carrier gas with RuO₄ is removed in the space between the showerhead and the wafer (not the entire chamber) before the next reactant (H₂) is introduced. This differs from an ALD process in which one reactant must be fully evacuated from the chamber before the next reactant is introduced.

In step 206, after the surface of the substrate has been dosed with a H₂ plasma, the H₂ flow is shut-off, and a purge gas is introduced for 0.5-10 seconds through the showerhead and the purge gas inlet port at a flow rate of 100-400 sccm to sweep the excess H₂ from the chamber volume and also remove excess H₂ that may be physisorbed on the substrate leaving a chemisorbed layer of H₂ on the wafer surface. Simultaneously, the chuck may be moved upwards to the upper process position (5-20 mm substrate to showerhead spacing) while still keeping the wafer clamped and the pressure controlled to the range of 0.2-0.8 Torr either by a throttling valve mounted on the port connected to the dry pump or by adjusting the purge flow.

Step 108 is repeated multiple times (typically 2-10 times) to deposit 5-40 angstroms of Ru as a nucleation layer for subsequent deposition.

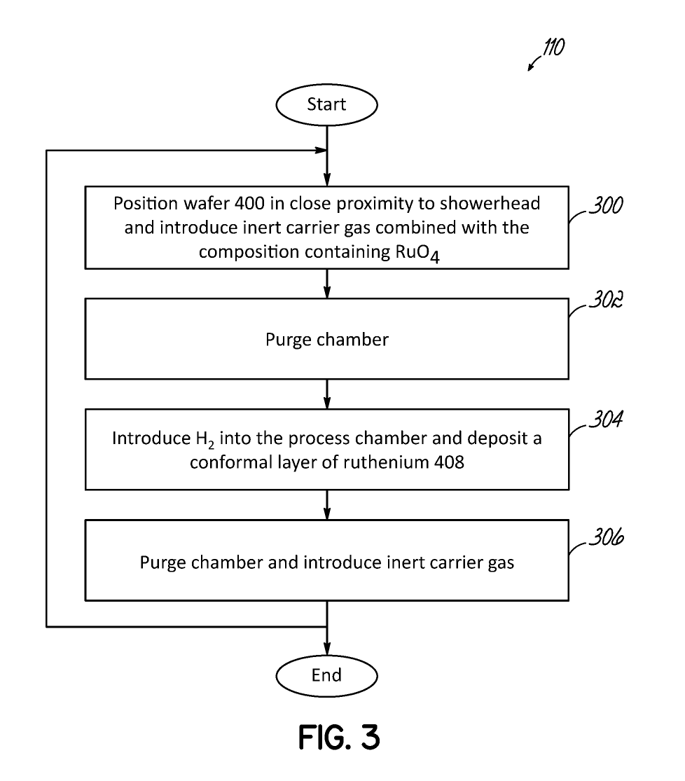

In step 110, a thicker layer 408 of ruthenium of the desired thickness is deposited via thermal ALD (T-ALD). Step 110 comprises multiple sub-steps 300-306 that are hereby described with reference to FIG. 3.

In step 300, the chuck is moved bringing the substrate in close proximity (5-20 mm) to the showerhead. The carrier gas, carrying components of the composition is introduced for 0.5-10 seconds through one zone of the showerhead. The flow rate of the carrier gas is 50-200 sccm while that of the composition is 50-200 sccm. An inert purge gas at 100-400 sccm is introduced through the purge port. The chamber pressure is maintained in a range of 0.2-0.8 Torr either by a throttling valve mounted on the port connected to the dry pump or by adjusting the purge flow.

After the surface of the substrate has been dosed the flow is shut-off and in step 302 a purge gas is introduced for 0.5-10 seconds through the showerhead and the purge gas inlet port at a flow rate of 100-400 sccm to sweep the composition components of step 300 from the chamber volume and also remove excess RuO₄ that may be physisorbed on the substrate leaving a chemisorbed layer of on the wafer surface. The chamber pressure is maintained in range of 0.2-0.8 Torr either by a throttling valve mounted on the port connected to the dry pump or by adjusting the purge flow.

In step 304, once the chamber has been purged of excess composition, H₂ is introduced for 0.5-10 seconds through the second zone on the showerhead. An inert purge gas at 100-400 sccm is introduced through the purge port and may additionally be introduced through the showerhead. When the H₂ delivery valve connected to the showerhead is opened, the H₂ stored in the reservoir is efficiently delivered to the process chamber. The H₂ reacts with the chemisorbed RuO₄ to form 2-4 A of Ru. During this step, the chamber pressure is maintained in range of 0.2-0.8 Torr either by a throttling valve mounted on the port connected to the dry pump or by adjusting the purge flow.

In step 306, after the surface of the substrate has been dosed with H₂, the H₂ flow is shut-off and a purge gas is introduced for 0.5-10 seconds through the showerhead and the purge gas inlet port at a flow rate of 100-400 sccm to sweep the excess H₂ from the chamber volume and also remove excess H₂ that may be physisorbed on the substrate leaving a chemisorbed layer of H₂ on the wafer surface. The chamber pressure is maintained in range of 0.2-0.8 Torr either by a throttling valve mounted on the port connected to the dry pump or by adjusting the purge flow.

Step 110 is repeated multiple times (typically 50-200 times) to deposit 150-800 angstroms of Ru as a nucleation layer for subsequent deposition.

At step 112, a periodic plasma densification may be performed every 5-20 cycles of deposition to control the film stress. In this process, 100-400 sccm of inert gas is introduced into the chamber through the showerhead and inert gas inlets, the chamber pressure is regulated in the range of 50-300 mTorr, and the film is densified by a 200-500 W RF plasma for 10-30 seconds. After the densification step is completed, the thermal ALD cycles are resumed.

Following the completion of deposition, a pump-purge sequence is performed. In this step, an inert purge gas at 100-400 sccm is introduced through both zones of the showerhead and the purge gas inlet for 0.5-10 seconds with the chamber pressure in the range of 0.1-1 Torr followed by a pump-down step in which the gases are shut-off and the chamber is pumped down to 0.01-0.1 Torr. The pump purge is repeated several times (e.g., 10) to remove trace amounts of reactants (RuO₄ and H₂) from the process chamber.

All gas flows in the chamber are stopped and the chamber is pumped down to base pressure (which is typically 10⁻⁶ to 10⁻⁴ Torr) by the turbo-pump. The sequence of steps involved in loading the wafer is reversed so that the wafer is readied for removal from the process chamber.

The slit valve that connects the module to the central wafer handler opens thereby providing the wafer robot in the central wafer handler access to the process module.

The robot in the central wafer handler transfers the wafer from the chamber into the pumped down load-lock.

After desired processing of the wafers in the load-lock is completed, the load-lock is vented to atmospheric pressure and the wafers are removed from the load-lock.

FIG. 4 illustrates in schematic style, the layers previously described. FIG. 4A illustrates a use for the processes of the current application, in the making of a trapezoidal shaped writer pole 410 with leading/trailing/side shields 412.

Referring to FIGS. 5-11, details of sub-systems are now described. Many of these subsystems have been referred to already in the preceding process description.

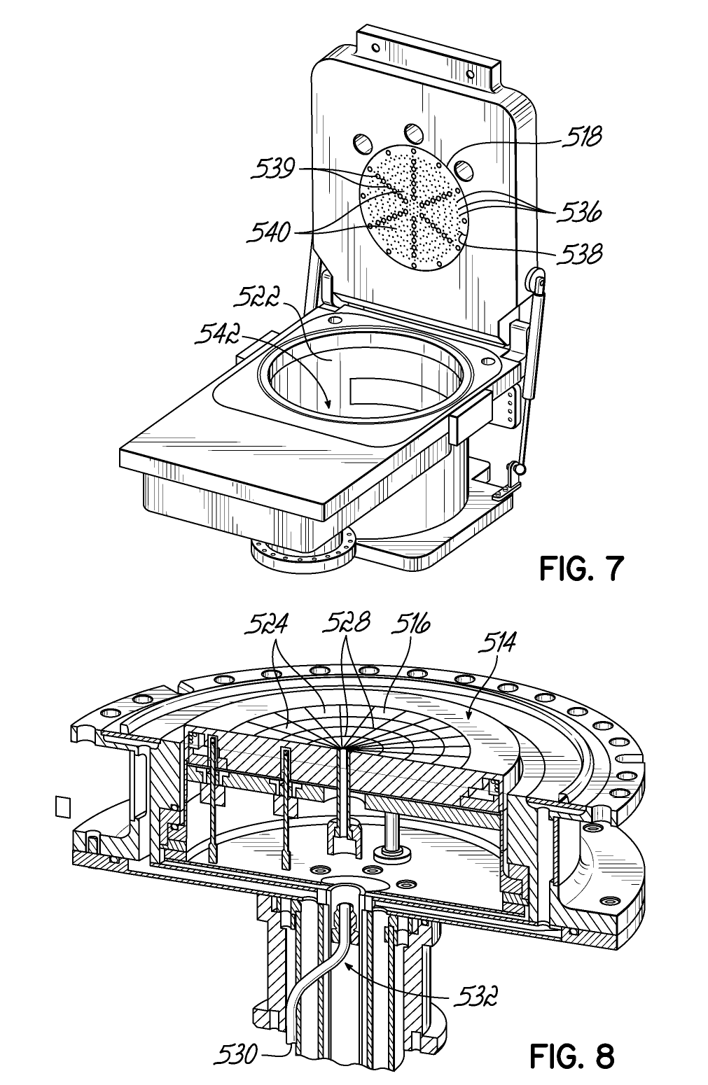

The chamber mounted on a frame 521 is typically constructed from stainless steel or aluminum with a controllable inner wall 522 (FIG. 7) temperature of room temperature (RT) −80° C. and contains the heated, temperature controllable, movable chuck 516 with associated wafer clamp 514. The chuck heating may be provided in one or more zones 524 (FIG. 8) in order to achieve good temperature uniformity (typically <±2° C. variation at 200° C.). The chuck's top surface 526 contains a number of grooves 528 for uniform distribution of a thermal heat transfer gas, such as Helium. Helium is fed through a backside gas line 530 connected to the chuck. The backside gas line has an RF isolator 532 to prevent RF power fed to the chuck from traveling down the gas line to the exterior of the chamber.

The frame of the process module also accommodates the other sub-systems such as the gas delivery and precursor delivery systems 504, 505, control electronics and vacuum pumping system 506.

The chamber 502 has a number of pressure gauges to sense base pressure (10⁻⁴ to 10⁻⁷ Torr), process pressures (10-1000 mTorr) and pressures encountered during chamber venting and pump-down (1 Torr-760 Torr). These gauges should be chemically inert to the precursor and may also be temperature controlled to prevent condensation of precursor within the pressure gauges.

The surface of the chuck is connected to an RF generator 535 typically operating at 13.56 MHz with an intervening matching network designed to efficiently transfer power from the generator to the chuck. The outer envelope of the chuck is grounded so that when the wafer is placed on the chuck, only the wafer and the wafer clamp are at RF potential.

For wafer loading, the slit valve opens thereby providing the wafer robot in the central wafer handler access to the process module 500. The robot in the central wafer handler (not shown) transfers a wafer from the pumped down load-lock into the chamber 502. The wafer 400 is loaded onto wafer lift pins. The robot end-effector retracts from the process chamber and the slit valve is closed. The movable, heated (typically ˜200° C.), temperature controlled chuck 516 moves upwards to engage with the wafer and then wafer clamp ring 514. The wafer clamp ring holds the wafer securely against the chuck. If an electrostatic chuck is used, the wafer is placed on wafer lift pins, the chuck moves upward to lift the wafer off the pins and then electrostatically chucks the wafer. The chuck then continues to move upwards to engage with the wafer ring. In this case, the wafer ring may not physically contact the wafer surface since it does not provide a clamping function.

Facing the chuck is the temperature controlled showerhead 518 that typically operates at room temperature (RT) −80° C. The showerhead has a number of small holes 536 distributed across its face 538 that are organized into multiple concentric zones 539. The zones can be interconnected to form two primary zones 540 through which the reactants can be introduced. In this instance, composition may be introduced through one of the primary zones 540, while H₂ is introduced through the other primary zone. When multiple zones 539 are used, an inert gas flow is continually maintained through the idle (not-active) zone to prevent backstreaming of the reactants into that zone. During purging, inert gases are introduced through both primary zones 540. As described previously, a single zone showerhead may be used. Multizone showerheads are not required.

In addition to the gas inlets through the showerhead 518, additional gas inlets 542 are provided in the base of the chamber and in the vicinity of the slit valve. Purge gases are typically introduced through these inlets to keep these regions of the chamber 502 clear of reactant gases or to provide gas ballast and stable chamber pressure control.

The chamber can be pumped down by a dry pump (not shown) connected to one of the pump out ports via a throttling gate valve that can both isolate the chamber from the pump or regulate the effective pumping speed of the pump in order to achieve the desired pressure. The dry pump is used to pump down the chamber from atmospheric pressure and also for process steps that operate at higher pressures as described above.

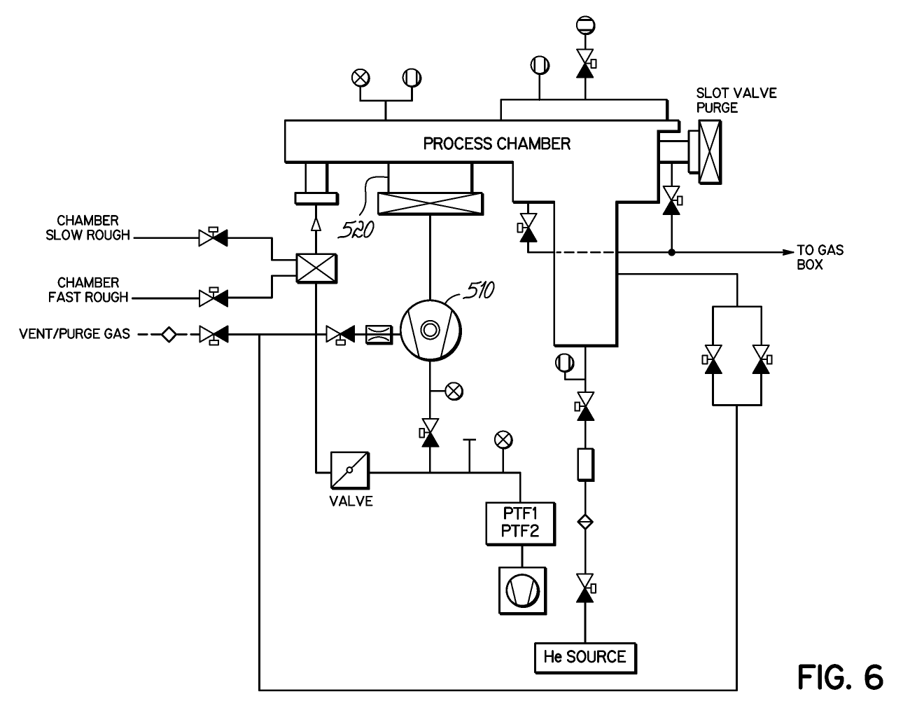

Also connected to the chamber is the turbo pump 510 (FIG. 6) with its own throttling gate 520 valve that can both isolate the chamber from the pump or regulate the effective pumping speed of the pump in order to achieve the desired pressure. The turbo pump is used to pump the chamber down to base pressure once the chamber pressure is below 150 mTorr. The turbo pump is also used for process steps that operate at lower pressures as described above.

The gas delivery system comprises (FIG. 5) a number of gas sticks 544 to deliver process gases as well as a bubbler system 546. Each of the gas sticks typically comprises a pressure regulator, gas filter, a mass flow controller with upstream and downstream valves, and a final control valve mounted close to the corresponding gas inlets on the chamber such as the showerhead 518 or the inert gas purge. The gas stick for H₂ may also include a fixed volume or an extended gas line to serve as a gas reservoir.

Referring to FIG. 9, a precursor delivery system is typically a bubbler 602 although other forms such as vapor draw or direct liquid injection may also be used. The carrier gas 604 is fed through a gas stick as described above into the dip tube 606 of the bubbler. The carrier gas 604 bubbles through the composition 608 contained in a vessel, such as the ampoule 610, and a mixture 612 of the RuO₄ and solvents and carrier gas exits the ampoule. The pressure in the headspace 614 of the ampoule is controlled by a needle valve (not shown) that is connected to the outlet of the ampoule. A pressure gauge 615, for example a capacitance manometer, is used to monitor the headspace pressure also referred to as ampoule pressure 617 (FIG. 10). The outlet stream of the bubbler may be fed to the chamber 502 through a control valve (not shown) located close to the showerhead or to a divert line that is connected to the foreline of the dry pump. Similarly, the carrier gas 604 flow may be directed into the ampoule or into a bypass line connected to the foreline of the dry pump. During the execution of the recipe, the flow of the carrier gas 604 is toggled between the inlet to the ampoule and the bypass line so that a steady flow through the mass flow controller (not shown) is maintained. A diverter line (not shown) on the outlet of the ampoule is primarily used during ampoule installation and setup procedures which involve pumping out of all the lines connected to the ampoule prior to or following ampoule replacement, and to pump out the inert packaging gas contained in the headspace of the ampoule when the ampoule is installed.

The precursor delivery system may also have provisions for connecting an external bulk-refill system 650 that periodically fills the ampoule from an external tank 652 having a solution 654. To enable automated operation, the ampoule may have one or more level sensors 656 that allow the user to set the low, high and overfill (alarm) levels. This is in addition to, or instead of, the pressure gage 617 that may also serve a similar function. The ampoule may be temperature controlled either by controlling the temperature inside the precursor delivery cabinet or by actively heating/cooling the ampoule with a temperature controlled jacket or temperature controlled liquid bath.

The internal surfaces of the ampoule 610 are protected by a glass liner (not shown) or preferably coated with a bilayer of Si and SiO₂ 657 to prevent reactions between the composition and the ampoule wall. The gas lines and chamber surfaces that are in contact with composition may also be coated as an additional precaution.

The bulk refill system 650 may be automated, or it may be manual. In either case, the replenishment solution 654 should not be the same as the composition 608, but instead should be a mixture of at least one solvent and RuO₄ so that over time the composition 608 is kept near or at a target concentration.

FIGS. 10 and 11 illustrate that ampoule pressure 617 varies during a production run as the composition 608 in the ampoule 610 is consumed. The pressure 617 in the ampoule is a function of the vapor pressures of the ruthenium tetroxide in solution, and the solvents. FIG. 10 illustrates the situation where the ruthenium tetroxide is dissolved in two solvents designated S1 and S2. Because S1 and S2 have different vapor pressures, S1 having a higher vapor pressure than S2, S1 is consumed faster and its % concentration decreases while the % concentration of S2 increases, relatively. In this illustration, at approximately 5300 cycles, the % S1 crosses the 20% mark, and the % S2 crosses the 80% mark on the chart. The overall ampoule pressure is at approximately 203 torr. This relationship is consistent. Therefore, measuring the overall ampoule pressure provides an indication of the solvent concentrations. The repeatability of this, and its usefulness, is explained further with reference to FIG. 11.

The range of the horizontal axis of FIG. 10 is repeated multiple times within horizontal axis of FIG. 11. In FIG. 11, two solvents have desired targets of 70 and 30 percent. Or, stated with an exemplary range, 70-72 percent and 30-28 percent. Because S1 is consumed faster than S2 and, therefore, depleted from the vessel containing the composition at a higher rate, at approximately 5300 cycle intervals they are at a concentration of 80 and 20 weight percent respectively. The refill system 650 is then activated so that the replenishment liquid 658 enters the ampoule and combines with the remaining composition 608 adjusting the % concentrations back to the desired target as indicated by the vertical portions in FIG. 11. Thus, this method of refilling a process composition 608 composition with a replenishment composition 658 restores the precursor 612 being delivered to the chamber to a desired range, providing consistent results in a production environment. The ranges illustrated are examples, and have been determined to meet the requirements for consistent production, but they are not meant to be limiting. Other ranges and limits may be used, depending on process conditions and the product characteristics being sought.

Instead of overall ampoule pressure, the composition level (as determined by liquid height or weight, for example) may be used in a similar manner. It is also possible to know when it is time for refill based on the number of cycles run, in other words the location on the X-axis of FIGS. 10 and 11.

For a numerical example, the initial composition 608 may include 700 ml (milliliters) of S2 and 300 ml of S1. After a given number of cycles, 200 ml of the composition 608 may remain, of which 160 ml is S2 and 40 ml is S1. The make-up solvent 654 should contain (700 ml-160 ml)=540 ml of S2 and (300 ml-40 ml)=260 ml of S1 to replenish the ampoule, along with the appropriate mass of RuO₄.

Although a single system is drawn in FIG. 9, more than one precursor delivery system (504, 505) as in FIG. 5, may be installed. For example, the second channel could be used for feeding the precursor for the seed layer. The second channel may be constructed and operated in a manner similar to the first precursor delivery system, or it may be different.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A chemical composition comprising:
a first solvent;
a second solvent; and
ruthenium tetroxide (RuO₄) in the first and second solvents at a concentration greater than 1.0 wt. %.

2. The chemical composition of claim 1 wherein the concentration of the ruthenium tetroxide ranges from 1.0 wt. % to 1.2 wt. %.

3. The chemical composition of claim 2 wherein the first solvent is at a concentration less than 30% and the second solvent is at a concentration greater than 70%.

4. The chemical composition of claim 2 further comprising: water at less than 10 PPM H₂O.

5. The chemical composition of claim 1 wherein the first solvent is at a concentration less than 30% and the second solvent is at a concentration greater than 70%.

6. The chemical composition of claim 1 wherein the concentration of the ruthenium tetroxide ranges from 1.6 wt. % to 1.7 wt. %.

7. The chemical composition of claim 6 wherein the first solvent is at a concentration less than 30% and the second solvent is at a concentration greater than 70%.

8. The chemical composition of claim 6 further comprising:
water at less than 10 PPM H₂O.

9. The chemical composition of claim 1 wherein the concentration of the ruthenium tetroxide ranges from 1.0 wt. % to 1.7 wt. %.

10. A process comprising:
providing a volume of a first mixture containing a first solvent and a second solvent in a first ratio of the first solvent to the second solvent;
placing the volume of the first mixture in a vessel;
vaporizing the first solvent and the second solvent in the vessel to form a vapor;
releasing the vapor from the vessel such that a volume of a second mixture remains in the vessel;
determining a second ratio of the first solvent to the second solvent in the volume of the second mixture remaining in the vessel;
in response to determining the second ratio, determining a third ratio of the first solvent to the second solvent for a volume of a third mixture to combine with the volume of the second mixture remaining in the vessel such that the first ratio is approximately reestablished when the volume of the second mixture and the volume of the third mixture are combined.

11. The process of claim 10 wherein providing the volume of the first mixture comprises:
blending a volume of the first solvent with a volume of the second solvent to provide the volume of the first mixture.

12. The process of claim 10 wherein the first and second solvents have different vapor pressures such that, when the volume of the second mixture remains in the vessel, the second ratio differs from the first ratio.

13. The process of claim 10 wherein the first ratio ranges from 30 vol. %:70 vol. % to 28 vol. %:72 vol. %.

14. The process of claim 10 wherein the second ratio ranges from 30 vol. %:70 vol. % to 20 vol. %:80 vol. %.

15. The process of claim 10 wherein the mixture has less than 10 PPM H₂O.

16. The process of claim 10 wherein the mixture has less than 5 PPM H₂O.

17. The process of claim 10 wherein vaporizing the first solvent and the second solvent comprises:
heating the vessel to form the vapor; and
flowing a carrier gas through the vessel.

18. A process comprising:
obtaining a mixture containing RuO₄, a first solvent, and a second solvent combined with the first solvent in a ratio of 30 vol. % to 70 vol. %;
placing the mixture in a vessel coupled in fluid communication with a deposition system;
conducting a deposition process that supplies a vapor containing the first solvent, the second solvent, and RuO₄ from the vessel to the deposition system, and that depletes the first solvent from the mixture in the vessel at a higher rate than the second solvent; and
replenishing the vessel using a replenishment mixture containing RuO₄, the first solvent, and the second solvent combined with the first solvent at a second ratio that is greater than 30 vol. % to 70 vol. %.

19. The process of claim 18 wherein the deposition process is ALD or CVD.

20. The process of claim 18 wherein replenishing the vessel comprises:
initiating the replenishing based upon a measurement of decreasing pressure in the vessel.

21. The process of claim 18 wherein replenishing the vessel comprises:
after the deposition process, initiating the replenishing based upon a measurement of a volume in the vessel.

22. The process of claim 18 wherein replenishing the vessel comprises:
initiating the replenishing based upon a measurement of decreasing level in the vessel.

23. The process of claim 18 wherein replenishing the vessel comprises:
initiating the replenishing based upon a measurement of number of deposition cycles performed.

24. The process of claim 18 wherein replenishing the vessel comprises:
automatically supplying the replenishment mixture from a bulk refill container to the vessel.
